(19) United States
(12) Patent Application Publication
(10) Pub. No.: US 2010/0039234 A1
(43) Pub. Date: Feb. 18, 2010

(54) RF POWER CONVERSION CIRCUITS & METHODS, BOTH FOR USE IN MOBILE DEVICES

(75) Inventors: Marcello Soliven, Glendale, AZ (US); Tamio Saito, Cupertino, CA (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: IVI SMART TECHNOLOGIES, INC., New York, NY (US)

(21) Appl. No.: 12/542,522

(22) Filed: Aug. 17, 2009

Related U.S. Application Data
(60) Provisional application No. 61/089,440, filed on Aug. 15, 2008.

(51) Int. Cl. H04Q 5/22

(52) U.S. Cl. 340/10.1

(57) ABSTRACT

This patent application teaches and describes radio frequency (RF) power conversion circuits and methods both for use in mobile devices (such as smart cards). Embodiments of the present invention include wireless personal ID cards or dongle including a fingerprint sensor. A fingerprint matching system can reside on cards. Power provided to the fingerprint sensor and on board processer(s) can be provided by a wireless signal provided to the card. The card can include an RF power conversion circuit configured to receive wireless RF energy and convert the wireless energy for powering electronics on the card. Other aspects, embodiments, and features of the present invention are also claimed and described.

### CROSS REFERENCE TO RELATED APPLICATIONS & PRIORITY CLAIM

This patent application claims the benefit of and priority to U.S. Provisional Patent Application No. 61/089,440, entitled RF POWER CONVERSION CIRCUIT, and filed 15 Aug. 2008, which is hereby incorporated herein by reference as if fully set forth below. Embodiments of the present invention may also utilize technology disclosed in U.S. Pat. No. 7,278,025 and PCT Application Publication Number WO 2005/104704; both of these publication disclosures are hereby incorporated herein by reference as if fully set forth below.

### TECHNICAL FIELD

Embodiments of the present invention relate generally to portable verification devices, and more particularly, to a smart card having biometric data verification features and a dual purpose receiving antenna that can be used for wireless power transfer and data modulation.

### BACKGROUND

RFID (Radio Frequency Identification) technology provides for near-field (short-range) wireless tracking of inventory as well as enabling users for near-secure access or transactions and other applications. The ISO-14443 specification defines near-field data communications between a reader device and one or more candidate devices. Candidate devices can include tags, badges, cards, or pocket devices commonly referred to as dongles, fobs, or smart cards.

When candidate devices are introduced into a reader devices' electromagnetic field, the candidate device detects the reader device's RF energy. A candidate device can then respond a data stream that modulates the energy field at the data rate. Candidate device(s) need not emit RF energy, but can provide a field load modulation that is detectable in the reader. A reader device can translate a candidate device's field load modulation into readable data (e.g., by using a microprocessor and supporting system).

Conventionally, a reader device emits RF energy at a frequency of 13.56 MHz. The energy field strength is specified at about 1.5 A/meter. Existing RFID systems are simple in that a candidate device's electronics may contain a secure code in the form of a sequence of up to 32 bytes. The candidate device responds to the entry of the RF field automatically with the data stream after introduction to the field in a process referred to as Answer to Reset (or ATR). The ATR data stream repeats while the candidate device is in the RF field. After the candidate device is removed from the field, the candidate device ceases to be active.

Traditional RFID candidate devices typically use a single track of coil windings to power the RFID-IC and respond with ATR data. This amounts to a current requirement that is typically on the order of about 5 to 10 mA during the ATR period which is less than two seconds. The design of conventional windings only delivers enough power to activate RFID transponder backscattering.

What is needed, therefore, are smart card systems enabling biometric data verification and using dual purpose antennas for wireless power transfer and data modulation. It is to the provision of such smart card devices, systems, and methods that the various embodiments of the present invention are directed.

### SUMMARY OF EXEMPLARY EMBODIMENTS

Embodiments of the present invention provide a stand-alone, self-powered smart card without the use of a battery or a powered card-holding accessory. According to one embodiment, a receiving antenna is reformulated into a multi-purpose, multi-function component of the smart card. The receiving antenna is integrated with an efficient power detection and conversion circuit that produces a voltage and current suitable for powering the electronics of the smart card. As a result, the smart card operates without requiring power supplied by a battery or a powered card-holding accessory. In some embodiments, the present invention can be utilized to harness energy from a source of wireless energy for charging a local power supply. Antenna components used in embodiments of the present invention can be configured to have multiple segments. A segment can be used to increase rectified voltage, and another segment can be controlled to modulate antenna impedance. Taps or tap positions can be used to segment single antenna into multiple segments. Other embodiments of the present invention are summarized below.

In some embodiments, the present invention can be portable wireless devices used for event actuation. Generally, portable wireless device can generally comprise a wireless power harnessing module, a biometric data comparison module, and a communication module. The wireless power harnessing module can comprise an antenna tuned to a resonant frequency. The resonant frequency can be associated with a source of an energy field. The antenna can be tuned with a capacitor placed in parallel with the antenna. The antenna can comprise several windings. When the antenna is positioned proximate the energy field, the antenna can interact with the energy field to generate electrical energy. This enables the wireless power harnessing module to source power and provide power to other components.

The biometric data comparison module can be coupled to the wireless power harnessing module. This coupling enables the wireless power harnessing module to power the biometric data comparison module. The biometric data comparison can be configured to enter a powered state when receiving adequate power from the wireless power harnessing module. When in the powered-on state, the biometric data comparison module can be operatively configured to receive external biometric data. The external biometric data can be obtained from an external source. After obtaining the external biometric data, the comparison module can compare the external biometric date to stored biometric data. Stored biometric data can be stored in a flash memory. Results of the biometric data comparison can be communicated by the communication module. Communication can be done wirelessly with an RF chip in some embodiments. Based on the communicated results received at a host device, event actuation can take place.

Portable wireless devices of the present invention can also have additional features. For example, the wireless power harnessing module, the biometric data comparison module, and the communication module reside within an ISO-7816 defined card outline. The wireless power harnessing module can comprise a rectifier circuit. The rectifier can be coupled to a low impedance winding of the antenna and a common ground. The rectifier circuit can be configured to convert AC voltage provided by the antenna to DC voltage. Embodiments of the present invention can also include a capacitor located in parallel with the antenna. The relationship between the capacitor and the antenna defines the resonant frequency of the antenna. In some embodiments, portable wireless devices have no local power source.

Portable wireless devices of the present invention can still yet have additional features. For example, antennas can be divided up into segments. The segments can be segmented by taps disposed at various tap positions. Antenna segments enable a single antenna winding to have multiple segments configured to carry out multiple functions. For example, the wireless power harness module can harness power from the energy field simultaneously to the communication module transmitting and receiving data from the energy field. To do this, the two modules can be connected to the antenna at different tap positions to use different antenna segments. The antenna can be shaped in an antenna coil pattern wound in a concentric fashion that comprises inner and outer windings. And some embodiments, the antenna coil pattern can be a continuous planar copper trace having tap positions located at various places along the coil pattern so the antenna has multiple segments configured to have different functions. In some implementations, the wireless power harnessing module comprises a rectifier circuit as a voltage doubling circuit that comprises two Schottky barrier diodes arranged in a full wave rectifying arrangement.

Other embodiments of the present invention can be implemented as wireless access control devices. The device can generally comprise a power circuit and a processor. The power circuit can be configured to have a default non-energized state and an energized state. The power circuit can be configured to receive energy from an energy field to enter the energized state so that the power circuit can source electrical power. Preferably, the power circuit is finely tuned to a carrier frequency of the energy field. The processor is coupled to the power circuit to receive to receive electrical power when the power circuit enters the energized state. The processor can be further configured to receive data from a sensor. In response to the received data, the processor can generate a signal corresponding to an access level.

Wireless access control devices of the present invention can also have additional features. For example, the processor can receive power only from the power circuit when energized and the processor is not configured to receive power from any other power source. This allows embodiments of the present to not have a required battery for operations. In some embodiments, the power circuit can comprise a power detection stage, a power conversion stage, and a receiving antenna. The receiving antenna can be integrated with the power detection stage. The antenna can be shaped and sized to produce electrical power when placed into an energy field. The antenna can also be used to receive and transmit wireless data signals. Also the antenna can be finely tuned to the carrier frequency of the energy field. Tuning can be accomplished using a tuning capacitor in a tank circuit format. In addition, the processor can be configured to control data communication between the wireless access control device and the source of the energy field during the energized state.

Still yet other embodiments of the present invention can be implemented as portable wireless devices capable of harnessing wireless energy. The devices can include an antenna and a rectifier circuit. The antenna and a tuning capacitor can be connected in parallel to form a tank circuit. The tank circuit can be finely tuned to a resonant frequency associated with a carrier base frequency of source of an energy field. The antenna can have several windings which when proximate the energy field, result in the antenna sourcing electrical current and voltage. The antenna can be divided into a plurality of segments. The segments can set off by a plurality of taps. The taps can be disposed at various places along the length of the antenna. One of the segments can be configured to receive and transmit data with the energy field simultaneously as the antenna receiving energy from the energy field. The rectifier circuit can be connected to a first tap and a second tap of the antenna. The first tap can be located on an inner antenna winding. The second tap of the antenna can be in electrical communication with a common ground. The rectifier circuit configured to convert the sourced electrical current and voltage to a DC energy source.

Portable wireless device embodiments of the present invention can also have additional features. For example, devices can have an antenna driving circuit. Antenna driving circuits can be configured to drive the antenna for data communication. The antenna driving circuit can be connected to a third antenna tap. The third tap can be located on an outer antenna winding. Device embodiments of the present invention can also include a voltage divider network. The network can be a capacitor network coupled to the rectifier. The rectifier can comprise a pair of diodes (e.g., Schottky diodes). The cathode of a first diode can be connected to the anode of a second diode. The anode of the first diode can be connected to ground. The cathode of the second diode can be connected to the voltage divider capacitor network. The voltage divider capacitor network can comprise a first capacitor connected in parallel to two series connected capacitors. The cathode of the second diode can be connected to a positive terminal of the first and second capacitors. The anode of the first diode can be connected to a negative terminal of the first and third capacitors. Capacitors in the voltage divider capacitor range in value from about 1 pF to about 100 pF, tuning capacitors can range in value from about 10 pF to 500 pF, antennas can have between 1 to 10 coil windings, and coil windings can have a width ranging between about 1 mm to about 10 mm. In some embodiments, the voltage divider capacitor network can comprise an energy storage capacitor configured to store energy. The energy storage capacitor having a value ranging from about 0.5 micro-farads to about 1000 farads.

Still yet other embodiments of the present invention can be implemented as a method of harnessing electrical energy from an energy field while simultaneously communicating data with the energy field. The method can generally comprise configuring and/or providing a portable device and a processor. The portable device can have a tank circuit tuned to a center frequency of an energy field. The inductor (or antenna) of the tank circuit can interact with the energy field to convert wireless energy into electrical energy. This enables the inductor can to source electrical power. A processor can be located on the portable device to receive electrical power sourced by the inductor. The processor can be configured to receive and provide data for communication with a device emitting the energy field. Data can be received and transmitted using coils of the inductor while the inductor is sourcing energy.

Method embodiments of the present invention can also include other features. For example, methods can include configuring portable devices to receive external biometric data, to test the biometric data against a stored biometric set of data, and to communicate results of the test via the inductor. Methods can include configuring the processor to communicate data by modulating the field load of the energy field. Methods can also include providing a voltage conversion circuit on the portable device to convert the energy sourced by the inductor from AC to DC and to regulate the DC voltage relative to a predetermined threshold.

Still yet, embodiments of the present invention can be implemented as a computer program product embodied in a computer-readable medium for execution by a processor or engine. The computer program product can comprise one or more algorithms to manage actions carried out by a processor in managing power and testing biometric data. The method can generally comprise harvesting power, testing biometric data, and communications. More specifically, the method can detect an appropriate power level being sourced by an antenna that is finely tuned to resonate at a center carrier frequency of an energy field. The power level can be provided in electrical form after the antenna converts wireless energy to electrical energy. The method can also include communicating with a biometric sensor to determine if the sensor detects presence of biometric data and has captured external biometric data. The received biometric data can be tested against stored biometric data to determine if the captured external biometric data matches the stored biometric data. Methods can also include issuing communication signals for wireless transmission from the antenna to another component. The communication signals comprise data about results of the biometric data test.

Methods embodiments of the present invention can also include other features. For example, a method may include instructing one of the biometric sensor or a system processor to enter a sleep mode if a low power level state is detected or to preserve power. A method can also include testing received biometric data against stored biometric data includes by configuring a system processor to extract digital data from the captured external biometric data to place the external biometric data in the same format as the stored biometric data. Methods can also include testing received biometric data against stored biometric data by generating a score indicative of the data test and wherein the score can determine a positive or negative test result relative to a predetermined threshold. Still yet, methods can include testing received biometric data against stored biometric data by generating a false acceptance ratio and a false rejection ratio and wherein a match condition can be achieved with the false rejection rate is less than the false acceptance ratio.

Other aspects and features of embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures, all embodiments of the present invention can include one or more of the advantageous features discussed herein. In other words, while one or more embodiments may be discussed as having certain advantageous features, one or more of such features may also be used in accordance with the various embodiments of the invention discussed herein. In addition, while discussion contained herein may, at times, focus on insurance applications, embodiments of the present invention can also be used in other settings. In similar fashion, while exemplary embodiments may be discussed below as system or method embodiments it is to be understood that such exemplary embodiments can be implemented in various systems, and methods. It should be understood that use of the terms module, processor, or engine herein should be construed to mean singular or plural versions of these terms such that certain actions can be carried in separate fashion or integrated together in a single module, processor, or engine. Some embodiments of the present invention can be implemented with hardware and/or software.

### BRIEF DESCRIPTION OF FIGURES

FIG. 1 illustrates a conventional RFID tag device with conventional tag circuitry.

FIG. 2 illustrates an RFID tag power circuit in accordance with some embodiments of the present invention.

FIG. 3 illustrates an RFID tag power circuit in accordance with some embodiments of the present invention.

FIG. 4 illustrates winding components of an RFID tag power circuit in accordance with some embodiments of the present invention.

FIG. 5 illustrates a schematic of an RFID tag power circuit in accordance with some embodiments of the present invention.

FIG. 6 graphically depicts an RF field in a proximate relationship with a smart card embodiment in accordance with some embodiments of the present invention.

FIG. 7 illustrates a block diagram of an RFID tag power circuit and biometric device in accordance with some embodiments of the present invention.

FIG. 8 illustrates a schematic of an RFID tag power circuit and biometric device in accordance with some embodiments of the present invention.

FIG. 9 illustrates a logical state diagram illustrating operational states of a biometric device in accordance with some embodiments of the present invention.

FIG. 10 illustrates a schematic of an alternative RFID tag power circuit and biometric device arrangement in accordance with some embodiments of the present invention.

FIG. 11 illustrates a functional block diagram of a power charging system in accordance with some embodiments of the present invention.

FIG. 12 illustrates a functional logic diagram showing a method of operating a power charging system in accordance with some embodiments of the present invention.

FIG. 13 illustrates a schematic diagram of a RFID transceiver module in accordance with some embodiments of the present invention.

FIG. 14 illustrates a schematic diagram of a RFID transceiver module circuit 1400 for use in charging applications in accordance with some embodiments of the present invention.

FIG. 15 illustrates a logical flow diagram 1500 of a method that can be used to implement embodiments of the present invention on a mobile device

### DETAILED DESCRIPTION OF PREFERRED & ALTERNATIVE EMBODIMENTS

To facilitate an understanding of the principles and features of the various embodiments of the invention, various illustrative embodiments are explained below. Embodiments of the present invention may be described below with reference to RFID reader applications. The embodiments of the invention, however, are not so limited. Indeed, embodiments of the present invention can include any portable device having a default unenergized state that is capable of harnessing power from an energy field as discussed herein for use with biometric data verification. Other embodiments can be devices needing recharging of local power supply as such recharging can be accomplished by harnessing energy from a wireless energy field. Still yet, other embodiments can be used to harness energy from an energy field while enabling transceiving of data between a portable device and another device (which can be the source of the energy field).

Briefly described, in preferred form, an embodiment of present invention includes a portable device having a wireless power reception circuit capable of harnessing power from an energy field for supply to a biometric data verification stage. Upon receipt of power from the power reception circuit, the biometric data verification stage can receive biometric data and compare the received data to previously stored biometric data. The portable device can have a communication component to transmit a signal (or modulate an existing signal) that contains information about the results of the biometric data comparison. Advantageously, the portable device need not have an independent power supply since it can harness power from an energy field for use in conducting biometric data comparison.

Various words or phrases used herein at times have multiple meanings and should not be limited in certain instances unless expressly stated. For example, coupled can mean directly coupled or indirectly coupled. Also the phrase “in electrical communication” can mean that components are in the same electrical path or are electronically coupled together. In some instances, where specific advantages or features of an embodiment of the invention are discussed, it should be understood that such advantages or features can be applicable to the other various embodiments of the present invention.

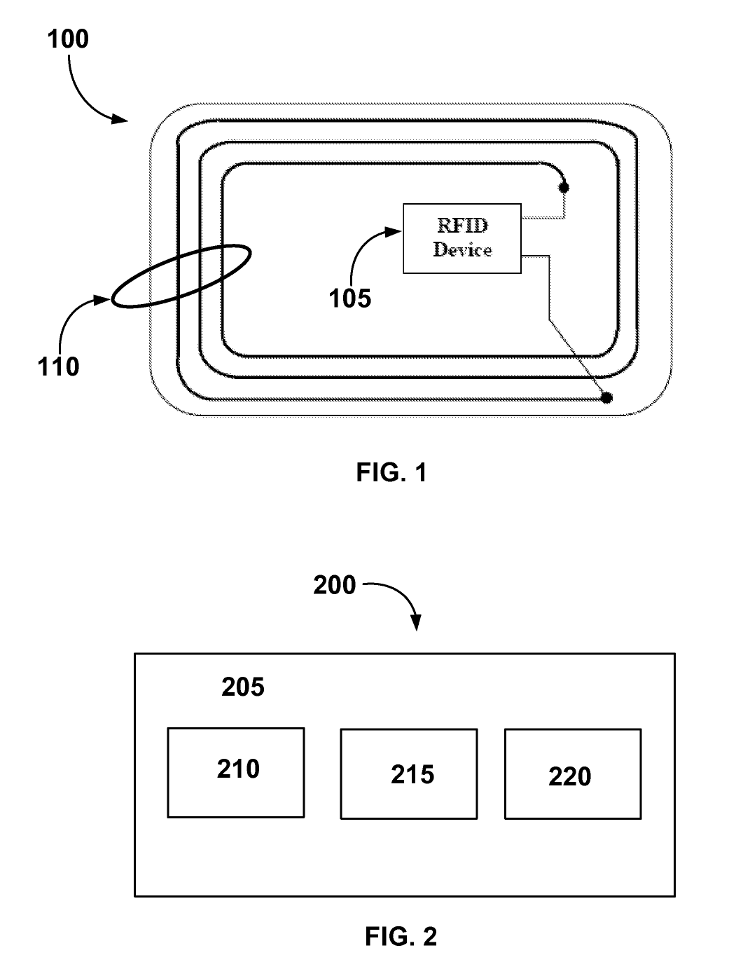

Referring now to the figures, wherein like reference numerals in some instances represent like parts throughout the views, exemplary embodiments of the present invention are described in detail. FIG. 1 illustrates a conventional passive RFID tag device 100 with conventional tag circuitry 105 and an antenna 110. The conventional RFID device 100 is tuned generally by design to receive energy from an RFID tag reader (not shown). The tuning is general in the sense that the antenna 110 is not tuned tightly to a specific frequency. For example, typically, RFID devices are tuned only by inductance, antenna features to about 17 MHz. The RFID tag device 100 is designed to only recover an RFID tag reader's magnetic field (H-Field) energy. Given the possibility that multiple RFID tag devices 100 can enter an RFID tag reader's energy field, the resonance of RFID tag devices is set to about 17 MHz (which is above the RFID tag reader's carrier frequency). This is purposefully done to enables the processing of multiple cards in close proximity within and RFID reader's RF field.

As pictured in FIG. 1, the conventional passive RFID tag device 100 includes an antenna 110. The antenna 110 is 3 turns of wire closely wound in a continuous, uninterrupted fashion. Electrically, this antenna 110 may be modeled as the secondary coil of an air core transformer. Energy is collected by the RFID tag device 100 and is used only for the short ART transmit period. General considerations for this antenna coil are for lower than optimum “Q” and loose tuning slightly above a 13.56 MHz frequency. As mentioned above, the loose tuning allows for multiple cards in an RFID's RF field and the detuning that occurs in that event. A typical RFID transponder (like the RFID device 105) will use approximately 25 mW during the short transmit period. Because of the specific design of the conventional passive RFID tag device 100, the device 100 is unable to harness sufficient amounts of RF energy for sourcing power (i.e., generating voltage and power) to adequately power electronics more complex than a simple RFID transponder (like the RFID device 105).

FIG. 2 illustrates a functional block diagram of portable device 200 used for event actuation in accordance with some embodiments of the present invention. The device 200 can be formed in the shape of a card 205 in some embodiments. In other embodiments, the portable device 200 may be a fob, dongle, PDA, cell-phone, smart phone, computer, or many other portable devices. The device 200 may include a local power source (e.g., battery) in some embodiments, and in other embodiments, the device 200 may not include a local power source. In those embodiments without a local power source, the wireless power harnessing module 210 is configured to harness wireless energy sufficiently to power electronic circuitry more complex than a simple RFID transponder.

According to some embodiments, the device 200 can generally include a wireless power harnessing module 210, a biometric data comparison module 215, and a communication module 220. In the embodiment pictured, the modules 210, 215, 220 can be coupled to each other to function and work together. In other embodiments, these modules 210, 215, 220 may be integrated together such that the functions of one or more modules can be combined in a single module. In smart card embodiments, it is currently preferred that the modules be sized and shape to fit within a card having sizes a defined in the ISO-7816 standard. Desired thicknesses range between about 0.7 mm to about 1 mm.

In embodiments with no local power source, the wireless power harnessing module 210 can be configured to recover energy from an energy field. The energy field can be, for example, an RF field emitted from a device (e.g., an RFID card reader). The wireless power harnessing module 210 can include an antenna having multiple coils windings of a conductor. Preferably the coil windings are planar in shape. As discussed further herein, the coil windings can be tapped at various places so that an antenna has multiple functions. Various tap points can be disposed on the antenna so that the antenna is a non-continuous, interrupted winding (as opposed to that shown in FIG. 1). This configuration enables the antenna to dually function as for power recovery and data transmission. By virtue of being placed in an energy field, the antenna can generate a current thereby harnessing wireless energy for use by the biometric data comparison module 215 and communication module 220.

The biometric data comparison module 215 can be configured to compare received external biometric data to stored biometric data. As such, the biometric data comparison module 215 can include a memory (e.g., flash memory) to store biometric data. In some embodiments, the stored biometric data can be a digital rendering of someone's fingerprint. The biometric data comparison module can also include a sensor (or other interface) to receive external biometric data. For example, the sensor can be a fingerprint sensor in some embodiments. When a finger is placed on the sensor, the sensor can capture external fingerprint data. The biometric data comparison module can also include a processor to receive captured external fingerprint data. The processor can be configured to compare the captured fingerprint data to stored fingerprint information. The results of the comparison can be provided as a score. If the score is above a certain threshold, then a match can be determined, and if the score is below a certain threshold, then a non-match can be determined.

Based on results of the comparison, the processor can instruct the communication module 220 to communicate information to a reader. Information can be communicated via a load modulation (or backscattering) protocol. If it is determined that a match occurred, the communication module can send this information to another device, and in response the device can actuate an event. For example, in the case of an access card, if a fingerprint match has been determined, then an RFID reader can send a signal to allow access.

It should be understood that embodiments of the present invention are not limited to access cards or access devices. For example, the device 200 can a fob, cell phone, smart phone, computer, dongle, or many other portable devices that may need power for functionality. In addition, the device 200 can be used for multiple applications. For example, the device 200 may used to authenticate a user prior to event actuating, including use of electronic devices and starting of vehicles. In other embodiments, the device 200 can be used as a source of power since it can harness power from wireless RF. The source of power may be used to charge an electronic device according to some embodiments.

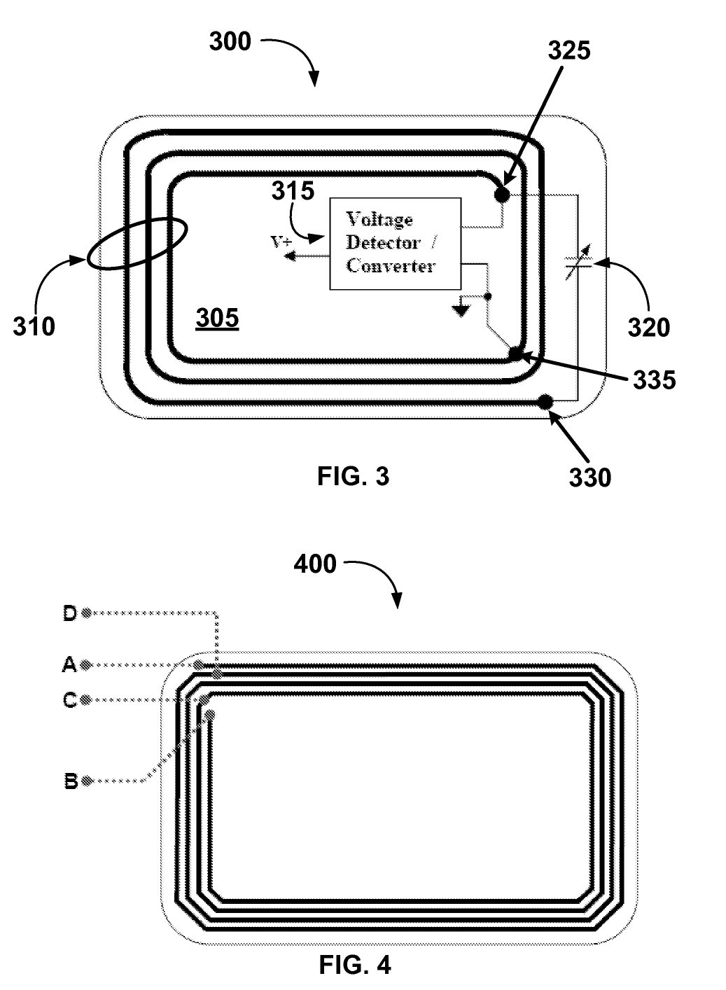

FIG. 3 illustrates a bio-verification card 300 in accordance with some embodiments of the present invention. As shown, the bio-verification card 300 generally comprises an antenna 310, a voltage detector/converter 315, and a variable capacitor 320. The bio-verification card 300 can be finely tuned to an energy field's center frequency. The tuning can be accomplished using the variable capacitor 320 to tune the antenna 310. In some embodiments, the variable capacitor 320 can be a fixed capacitor assuming a used center frequency is used. For example, if an energy field has a center frequency of 13.56 MHz, the variable capacitor 320 can have a fixed value ranging from between about 5 pico-farads to about 30 pico-farads. When implemented, the capacitor can have a fixed value to finely tune an antenna to a specific frequency to that the sensitivity of the antenna matches with the energy field to create a resonance event.

By virtue of finely tuning the antenna 310 to a specific frequency that substantially matches an energy field's center frequency, maximum energy from the energy can be recovered. In some embodiments, only one the bio-verification card 300 is placed in an energy field at any given time. In such a case, the antenna 310 coils' outer turns are resonant in the energy field's electrical field (aka E-field or energy field). Resonance is achieved by a parallel inductor/capacitor (L-C) combination (e.g., the antenna 310 and capacitor 320) which emulates an end-fed, monopole element. The resonance frequency and appropriate L/C values can be obtained using the resonance equation: resonance frequency (f) is equal to the inverse of 2 times Pi times the square root of L times C—f=1/(2π×√(L×C)). The antenna 310 configuration shown in FIG. 3 provides a transition in the coil's structure from electrical to magnetic when moving from the antenna's 310 outer turns toward the antenna's 310 inner turns. The innermost winding is a single-low-impedance winding that is the voltage source for the voltage detector/converter 315.

FIG. 3 also illustrate various tap positions 325, 330, 335 being disposed in the antenna configuration. Placement of multiple taps in this illustration (and as described in other illustrations herein) enables a single antenna structure to be multi-functional. The tap positions break the single antenna into multiple antenna segments. This enables space savings within a confined area when multiple antennas can not be utilized (e.g., in a smart card application). Tap position 325 is located at the end of the innermost antenna winding, tap position 335 is tied to a common ground, and tap position 330 is located at the end of the outermost winding. The voltage detector/converter 315 can be disposed between tap positions 325, 330 and the variable capacitor can be disposed between tap positions 330, 335.

FIGS. 4 illustrates an antenna arrangement 400 used for harnessing power of an energy field in accordance with some embodiments of the present invention. As shown in arrangement 400, an antenna winding 405 is wound close to the outer periphery of a confined space 410 (e.g., internal area of a smart card). The antenna winding 405 comprises four windings. In other embodiments the antenna windings 405 can have between 2 and 10 windings. Other winding values are also possible in accordance with the present invention.

Also as shown, the antenna winding 405 has a plurality of tap positions. The tap positions can be placed at various locations along the antenna winding 405 to interrupt the continuous flow of the antenna winding 405. Various tap positions also enable access to the varying impedance of the winding 405. As shown, tap A is located at the end of the outermost winding, tap B is located at the end of the innermost winding, tab C is located at a position on the second innermost winding, and tab D is located at a position on the winding closest to the outer winding. In this arrangement, the outermost winding is the high impedance winding with the innermost winding being a low impedance winding. Although taps A, B, C, and D are located in these positions in this embodiment, various other embodiments could have various tap positions along the antenna winding.

The windings 405 can have various characteristics in accordance with the various embodiments of the present invention. For example, the windings 405 can have a planar shape having a thickness ranging between about 10 microns to about 100 microns. In currently preferred embodiments, the thickness of the windings 405 can range between about 13 to about 60 microns. In addition, the windings 405 can be arranged so that no sharp turns are provided in the windings 405. As shown in FIG. 4, the windings 405 are configured to have smooth transition between segments. In currently preferred embodiments, angular transitions have angular turns about 45 degrees or less. Also, the windings can be made of various conductive metals or metal alloys. In some embodiments, the windings can be made with substantially pure copper traces. In other embodiments, the windings can be made with copper foil, stamped copper, etched conductors, copper plating, milled copper, pressed copper wire, silver, and aluminum.

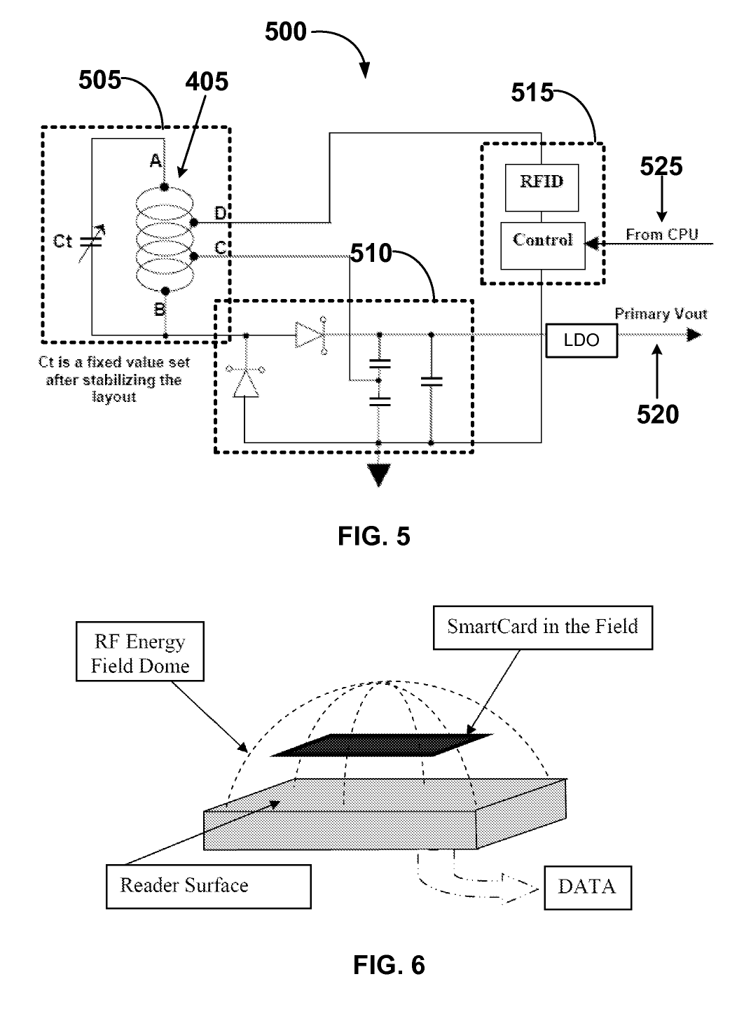

Now turning to FIG. 5, there is shown a schematic diagram of a power recovery/conversion circuit 500 in accordance with some embodiments of the present invention. The circuit 500 generally includes three modules: a power harnessing module 505, a power conversion module 510, and a control RFID module 515. The circuit 500 can also be configured to provide an output voltage (V_{OUT}) 520 and receive a control signal 525 from another component. The output voltage 520 can be provided from the interaction between the power harnessing module 505 and the power conversion module 510.

As shown, the power harnessing module 505 includes a capacitor 530 and an antenna 535. The capacitor 530 can be variable (as illustrated) or fixed at a certain value. The value of the capacitor 530 can be selected to tune the antenna 535 such that its winding can resonate at a certain frequency. The resonation frequency can be an energy field's center carrier frequency. Resonation enables maximum power transfer from an energy field to the antenna's 535 windings. As shown, the antenna's windings 535 can be tapped at various locations (similar those in FIG. 4). Potential from the taps B, C, D can be provided as inputs to power conversion module 510 and the control/RFID module 515.

When the antenna 535 encounters an energy field (e.g., an RF field) a current is generated thereby creating an AC voltage. This AC voltage can be accessed at tap B and provided to the power conversion module 510. The power conversion module 510 includes a rectifier 540 to convert the AC voltage to a DC voltage. The rectifier 540 includes two diodes coupled in a full wave arrangement. In currently preferred embodiments, the diodes are Schottky diodes. This type of diode enables effective harnessing of power from high frequency energy fields.

The diodes can also be coupled to a capacitor network 545. As shown, the capacitor network 545 can include two series capacitors in a parallel arrangement with a single capacitor. The capacitor network 545 can also be arranged in other configurations. The capacitor network 545 can filter the converted DC voltage. The capacitor network 545 can also include a super capacitor (ranging from 2 Farads to 10 Farads). In this arrangement, the circuit 500 can be used as fast charging device using only source energy provided from a wireless field.

The power recovery/conversion circuit 500 also includes a control/RFID module 515. The module 515 can be used to communicate with a device that provides an energy field (such as an RFID reader). Communication can be done via load modulation (also known as backscattering). In this arrangement, embodiments of the present invention (e.g., the circuit 500) can be used to advantageously simultaneously receive/convert power and transmit/receive data.

FIG. 6 graphically depicts an RF field in a proximate relationship with a portable device (e.g., smartcard) in accordance with some embodiments of the present invention. Projected at approximately 90 degrees from the reader surface, the RF energy field may be described as a “dome” of electromagnetic energy having a frequency of 13.56 MHz. Both electrical (E) and magnetic (H) fields are present; however the dominant field is magnetic. For ISO-14443, the typical field intensity is on the order of 1 Amp/meter. A typical RFID device uses 10 mA in the two second period (approximately) needed to detect and respond to reset conditions with the secured data stream. The dome of energy may extend for several inches from the reader surface. The reader's inductor or antenna is typically configured to permit a field height and radius of equal proportions. The typical dome provides useful energy within a dome of approximately 1 to 2 inches high. FIG. 4 depicts a model of the reader, the projected field, and a card in the field.

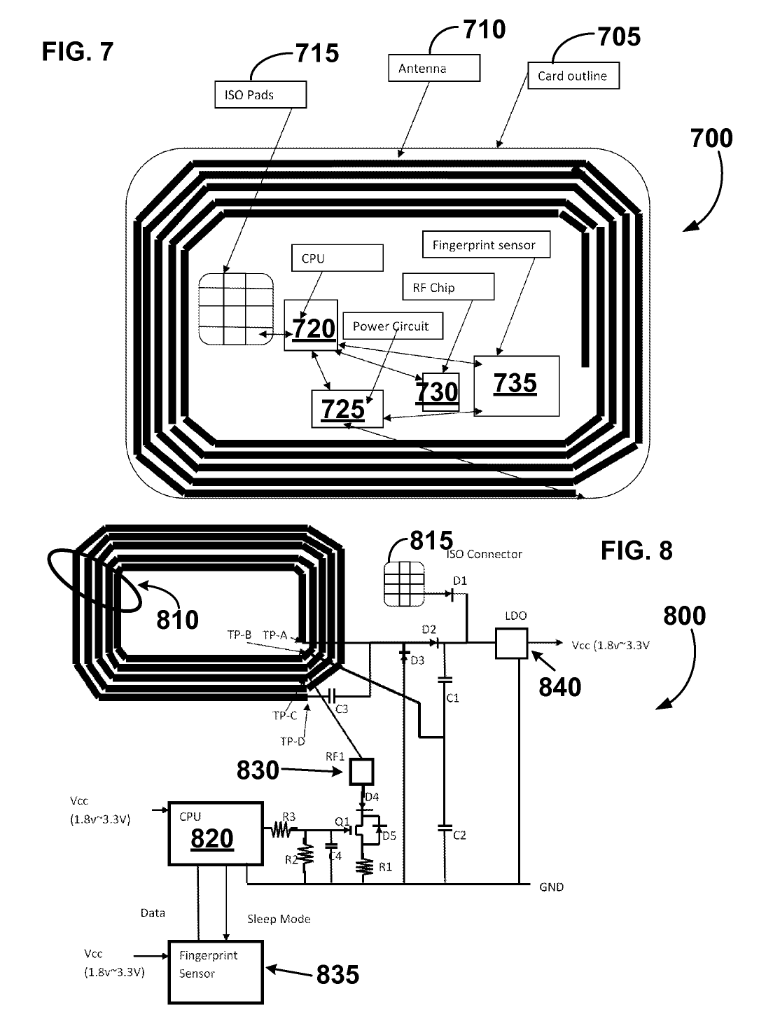

FIG. 7 illustrates a functional block diagram of a biometric device 700 in accordance with some embodiments of the present invention. As shown, the biometric device 700 can be sized and shaped as a card 705 (e.g., an access card or a smart card). In other embodiments, the biometric device 700 may be sized in shaped in other configurations. In some embodiments, the biometric device 700 may be integrated with other devices or a host device. These can include devices, such as fobs, dongles, cell phones, smart phones, computers, personal communication devices, and the like. When integrated with a host device, the biometric device 700 can be used to secure or enhance secure access to the host device.

As illustrated in FIG. 7, the biometric device 700 can comprise various components. The components can include an antenna 710, interface pads 715, a processor or microcontroller 720 (CPU), a power circuit 725, an RF chip 730, and a biometric sensor 735 (e.g., a finger pint sensor). As illustrated, the biometric device 700 does not include a local power supply (in other embodiments, the biometric device may include a lower power supply, such as a battery or solar cell system). By not having a local power supply, the biometric device 700 can be arranged and confined to a small space.

Even though the biometric device 700 lacks a local power supply, the biometric device 700 is equipped with features capable of harnessing power from an RF energy field. The antenna 710 can be used to harness wireless energy for use as a power source. For example, the antenna can receive RF energy and convert the RF energy to AC power (i.e., and AC voltage and current). This AC voltage can be converted to DC using the power circuit 725. The power circuit 725 can provide t his DC power (i.e., DC voltage and current) to the various other components. For example, the power circuit 725 can provide DC power to the CPU 720, the RF chip 730, and the fingerprint sensor 735. As shown in FIG. 7, the power circuit 725 can be electrically coupled to the CPU 720, the RF chip 730, and the fingerprint sensor 735.

In operation, the biometric device 700 can be configured to authenticate a user's finger print to actuate an event (such as entry access). To implement the authentication ability, the CPU 720 can have a memory and biometric data (e.g., a finger print template) can be downloaded into this memory. This can be done via the interface pads 715 in some embodiments. The biometric data can be associated with one or more users. In currently preferred embodiments, the biometric data is a finger print for a unique user. The finger print data can be a digital representation of the finger print and can be stored as a fingerprint template.

Using the biometric device, the unique user can position the device close to a source of RF energy, such as an RFID reader. Typically, RFID readers are located near entryways to restrict access. When a user with the biometric device approaches the RFID reader, the antenna 710 harvests energy from the RF field, the power circuit 725 converts the harvested power to DC, and then the DC voltage is distributed for use.

When receiving power, the fingerprint sensor 735 activates and captures external finger print data. The external finger print data is provided to the CPU 720. The CPU 720 compares the external finger print data to the stored fingerprint template. Based on the comparison, the CPU 720 can calculate a comparison score. The CPU 720 can then contrast the comparison score with a set threshold to determine if a match or no match condition has occurred. The threshold can be adjusted to ensure sensory integrity. If the CPU 720 determines that the external fingerprint data matches to stored template, the CPU 720 can proceed to take steps to communicate this information. For example, the CPU 720 can signal the RF chip 730 to generate a signal for wireless transmission by the antenna 710. The RF chip 730 may not necessarily send a signal; rather it may modify an RF reader's energy field (via load modulation/backscattering) with a certain data modulation pattern. Upon detecting the modulation of its energy field, the RF reader can then actuate an event. This event actuation can include such things as unlocking the door to an entry way or sending a start signal to another device.

All necessary power for capturing external fingerprint, calculation of matching, RF chip power, or an optional LED/display on the card is supplied from RF power through antenna. Exemplary standards for the RF energy field can include, but are not limited to, ISO 14443 A/B/C, ISO 15693, Mifare, and Felica. Depending on the communication protocol, an energy field can have a certain carrier frequency. In some instances, the carrier frequency can be 13.56 MHz. To achieve maximum power transfer, the antenna 710 can be fine tuned to resonate at an energy field's carrier frequency. For example, the antenna 710 can be tuned with a capacitor to resonate at 13.56 MHz so that the antenna 710 can maximize energy harvesting from the energy field.

The biometric device 700 can enhance and improve upon legacy access card systems. In certain security applications, many use wireless door access cards. Legacy cards and card systems, however, have no functions to authenticate card holders. This deficiency results in a weakness of legacy card situations: cards can be stolen, faked, or replicated by fraudsters. This activity can lead to unauthorized access which can result in criminal activity. Embodiments of the present invention address the weakness of legacy card systems. In particular, embodiments of the present invention authenticate card holders.

Embodiments of the present invention also enable non-battery card systems. If batteries are used in cards, there is always a risk of running out of battery power in the battery and thus at an important event losing battery power can cause serious problems. Power supply environment has to be always guaranteed as long as power on the reader is guaranteed. Embodiments of the present invention are designed to have a low dissipating power system and utilize efficient energy acquisition through a novel tuned antenna design (as discussed herein).

FIG. 8 illustrates a schematic of a biometric device 800 in accordance with some embodiments of the present invention. This figure illustrates details of a RFID tag power circuit 805 (such as power circuit 725). This figure also shows how the RFID power circuit 805 connects with antenna 810 at various tap positions.

As discussed herein, embodiments of the present invention can utilized a single antenna having various taps position along a single wound conductor. The various tap positions enable a single antenna winding to be multi-purpose: power harnessing and data transmission. As shown in FIG. 8, the antenna 810 has four taps: A, B, C, and D. Tap A is positioned at the terminal end of the innermost winding, tab B is located at a corner position of the second innermost winding, tap C is located at a corner position of the third innermost winding, and tap D is located at the terminal winding of the outermost winding. By virtue of placing taps B and C between taps A and D, the single antenna 810 is divided into segments. The segments enable the single antenna to have multiple functions.

Shown connected to the various taps in the drawings are various logical devices and circuit components. For example, the antenna coil is terminated with a ceramic capacitor C3 at taps A and D. C3 can be used to tune the antenna to a certain frequency (e.g., 13.56 MHz±1 Mhz). The certain frequency that antenna is tuned to can be the center frequency of an energy field's carrier wave. In currently preferred embodiments, C3 has a value ranging from 10 pF to 30 pF. The value can be more precisely 15 pF in some embodiments.

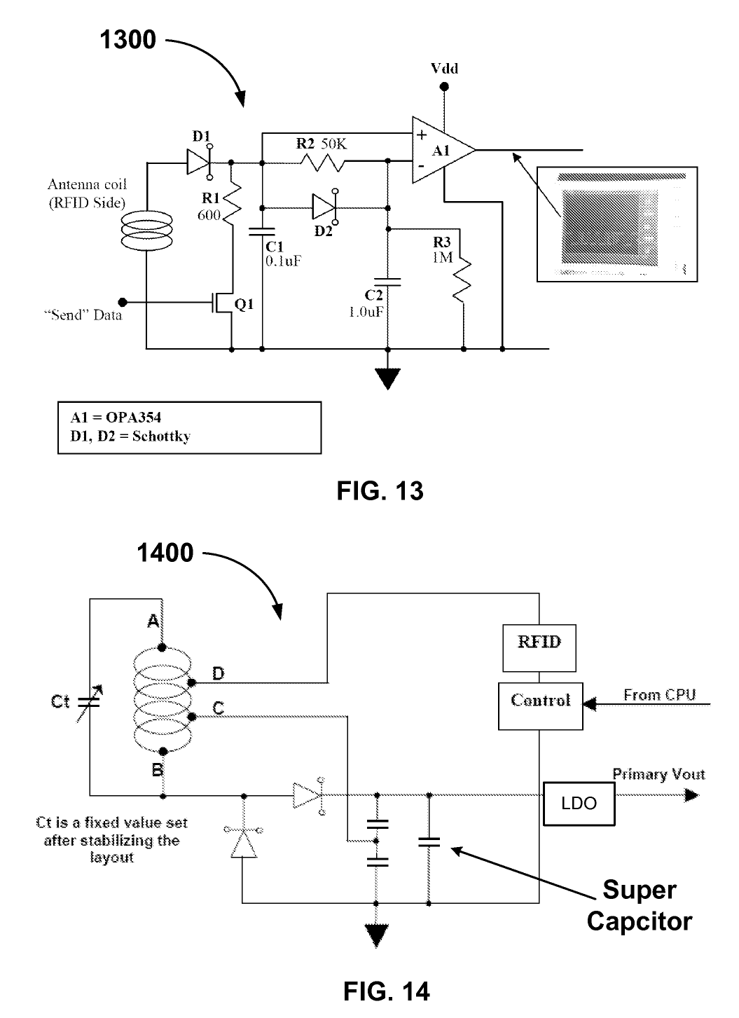

Tap C can be connected to the RF chip 830 so that the RF chip 830 can use the antenna for communication. In this arrangement, the RF chip 830 can generate signals for transmission using the antenna 810. In addition, the antenna can be used to receive data (e.g., see FIGS. 13-14). As a result, the single antenna 810 can be used to harvest power and communicate (receive data and transmit data). Data transmissions can be carried out by emitting wireless signals or modification of an energy's field load.

Certain of the antenna's 810 taps can be connected to devices to aid in harnessing power from an RF energy field. For example, and in currently preferred embodiments, tap A can be coupled to a rectifier. The rectifier can include two diodes: Schottky diodes D2 and D3. Tap B can be coupled to the interconnection of C1 and C2, with C2's other terminal being tied to ground. This configuration enables the rectified voltage to be regulated by a voltage regulator 840 (e.g., a Low Drop Out (LDO)). The voltage regulator 840 can be more than 6 volts. This rating is high enough to supply an output voltage of 3.3 VDC. This output voltage can be utilized by logical/digital devices, such as CPU 820. In currently preferred embodiments, C1 and C2 can be in the range of 1 micro-farad to 100 micro-farads. In some embodiments, C1=C2. Using the illustrated antenna and rectifying circuit, the LDO 840 can supply about 3.3 volt/50 mA to CPU 820 and a fingerprint sensor 835. Preferably, the CPU is rated to consume between 30-40 mA at 60 MHz clocking operation and the fingerprint sensor 835 consumes 7-10 mA during the finger print capturing process.

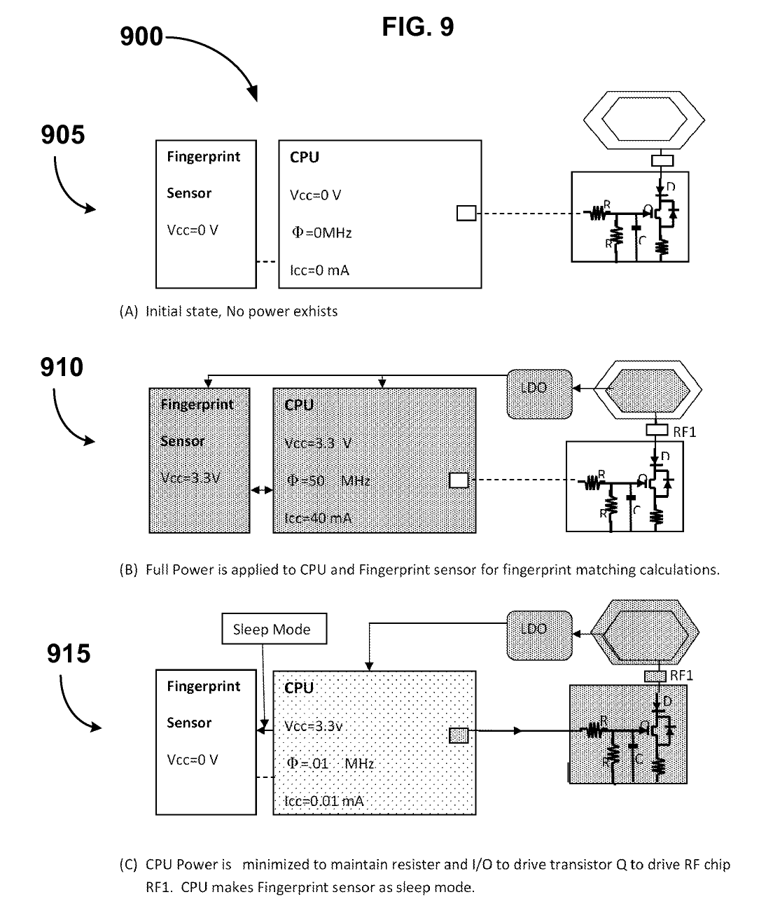

When the biometric device 800 is positioned proximate an energy source (e.g., an RFID card reader), the device will begin to operate (FIG. 9 explains additional operational state details). When operations initiate, the CPU 820 can signal the finger print sensor 835 to capture the fingerprint of a card holder. In response, the finger print sensor 835 captures finger print data. The captured finger print data can be sent to the CPU 820.

Upon receiving the captured finger print data, the CPU 820 can act on the data. The CPU 820 may take a digital rendering of the data or extract a simplified image from the raw, scanned finger print data. After acting on the captured finger print data, the CPU 820 can compare the extracted image to previously stored finger print data. To enable effective comparison, the stored finger print data and the captured finger should be obtained by the same method (e.g., same digital rendering algorithm or same data extraction method). Other finger print data simplification methods include but are not limited to thinning, noise removing, rotations, extracting Minutiae, and FFT (Fast Fourier Transfer).

To implement the comparison of the two data sets, the CPU 820 can implement a matching algorithm. The matching algorithm can retrieve the stored finger print data from memory and compare with the received external data. Results of the comparison may produce a comparison score. After obtaining the comparison score, the CPU 820 can determine if the score exceeds or falls below a predetermined threshold. In some embodiments, a comparison score that exceeds the threshold indicates a match condition and a comparison score that falls below the threshold indicates a no match condition.

After determining the existence of a match or no match condition, the CPU 820 can initiate control of the RF chip 830. For example, upon confirming a match condition, the CPU 820 holds the register of an IO port to output a signal to enable Q1 to drive the antenna 810 at tap C (tap C can be located at roughly the center of the whole antenna 810). By controlling the output signal to Q1, the CPU can toggle Q1's gate thereby turning Q1 off and on. This off and on modulates antenna transmission. The toggling activity, thus, enables the RF chip 830 to modulate data transmitted by the antenna 810.

While the CPU 820 is controlling Q1, the CPU 820 can hold its IO port. When doing this, the CPU 820 can reduce its clock cycle to induce a sleep mode or a low frequency clock mode. When entering a sleep mode, the CPU 820 can also instruct the finger print sensor 835 to enter a sleep mode. By entering a sleep mode, the CPU 820 and the finger print sensor consume less power thereby preserving power for other components.

By operating in this fashion, the biometric device 800 can obtain full power from a wireless energy source. This full power can be initially used by the CPU 820 and the finger print sensor 835 to focus on calculations. Then the device 800 can focus on sending signal data via RF chip 830. In testing of a prototype device, using a normal reader for one-fingerprint sensor ISO 14443A wireless card reader, a communication distance of 30mm has been confirmed. This distance is the same distance of normal ISO14443A card communication distance. So, even though there are many power hungry components on the biometric device 800, the biometric device 800 can communicate with the same reader at the same distance allowance.

The biometric device 800 can have various physical characteristics. For example, the antenna 810 is preferably made on a flexible PCB. The antenna's windings can be fabricated with planer copper traces. The antenna 810 preferably shares the same flexible PCB sheet with various other components and includes copper couplings to these other components. The other components can include the CPU 820, the RF Chip 830, a fingerprint sensor 835, and a voltage regulator 840. The flexible PCB sheet can be fabricated with, but no limited to, polyimide, mylar, PET, and kapton. The antenna's 810 windings can be made of laminated copper, plated copper, printed silver, combinations thereof, and many other conductive materials.

The antenna 810 can also have various other characteristics. For example, the antenna 810 coil can be made in a wound coil pattern. The wound coil pattern can be done so that a coil has a plurality of individual windings. The individual windings can have a thickness between about 10 microns to about 100 microns. The individual windings can also have a width ranging from about 50 microns to about 200 microns. Currently preferred embodiments have a width of about 100 microns with a thickness ranging between about 25 microns to about 35 microns. Thickness values should be selected to provide antennas having desired resistivity values. Such pattern can be patterned on one side of FPCB or both side of FPCB. Currently preferred coil winding embodiments include five windings with five turns. The windings can be positioned proximate the outer periphery edges of an access card. This configuration advantageously enables acceptance of a maximum magnetic flux from an RFID reader's energy field. The antenna 810 can be coiled so that the antenna 810 has angular turns less than about 45 degrees to limit eddy currents.

FIG. 9 illustrates a logical state diagram 900 illustrating operational states of a biometric device in accordance with some embodiments of the present invention. Generally, the several states show various operational stages of a portable device. A first state 905 shows a portable device in an initial state with no power, a second state 910 shows a portable device in range of an energy field at full power, and a third state 915 shows a portable device in range of an energy field with reduced power use to focus on data communication. Each of the states is discussed below in more detail with reference to an access card application. It should be understood, however, that the dual power harnessing and data communication states could be used in various other applications, including but not limited to, cell phone charging/data updating, smart phone charging/data updating, computer charging/data updating, personal music player charging/data updating.

Turning now to state 905, an access card is in an initial no-power state. In this state, the card is likely outside the range of an energy field. As a result, the access card's antenna can not harvest any wireless energy. Access cards in this state will likely remain in the initial, no-power state until brought in the range of an energy field source. A no-power state could occur when multiple, fine-tuned cards are placed in close proximity of an energy source. Typically, in this situation, the card closest to the energy source pulls power from the energy source while those cards further away receive little to no power due to the existence of the closer power. The status information shown in state 905 indicated the existence zero volts and amps in the initial state.

A next state is shown as state 910. State 910 can result when an access card is brought within range of an energy field (e.g., see FIG. 6). When this occurs an access card's antenna and power conversion circuit can recover and harvest power from the energy field. This power can then be provided to electronics within the card. The electronics can include a processor and a fingerprint sensor. The processor and the finger print sensor can be used to scan a user's finger print and compare the scanned finger print against a known finger print. This procedure can authenticate someone holding an access card. Advantageously, this enables embodiments of the present invention to authenticate a card holder to ensure the card holder is properly associated with an access card. Access cards may not need to remain in a full energized state (such as state 910) to carry out its functions. Indeed, to preserve energy and efficiently use harvested power, a process can be configured to switch on and off other components. An example of this is shown in state 915.

State 915 illustrates a feature of some embodiments of the present invention, where certain components are switched off or instructed to enter a sleep mode. By instructing components to enter a sleep mode, power usage is minimized and or focused for use by other components. As shown in state 915, the processor provides a sleep mode signal to the finger print sensor. When the finger print sensor is in sleep mode, the CPU can then direct adequate power to an RF chip. When powered, the RF chip can communicate with a card reader. State 915 also represents the ability to continuously receive and harvest power from an energy field and at the same time, communicate with an access card reader. In currently preferred embodiments, communication can be accomplished via field load modulation.

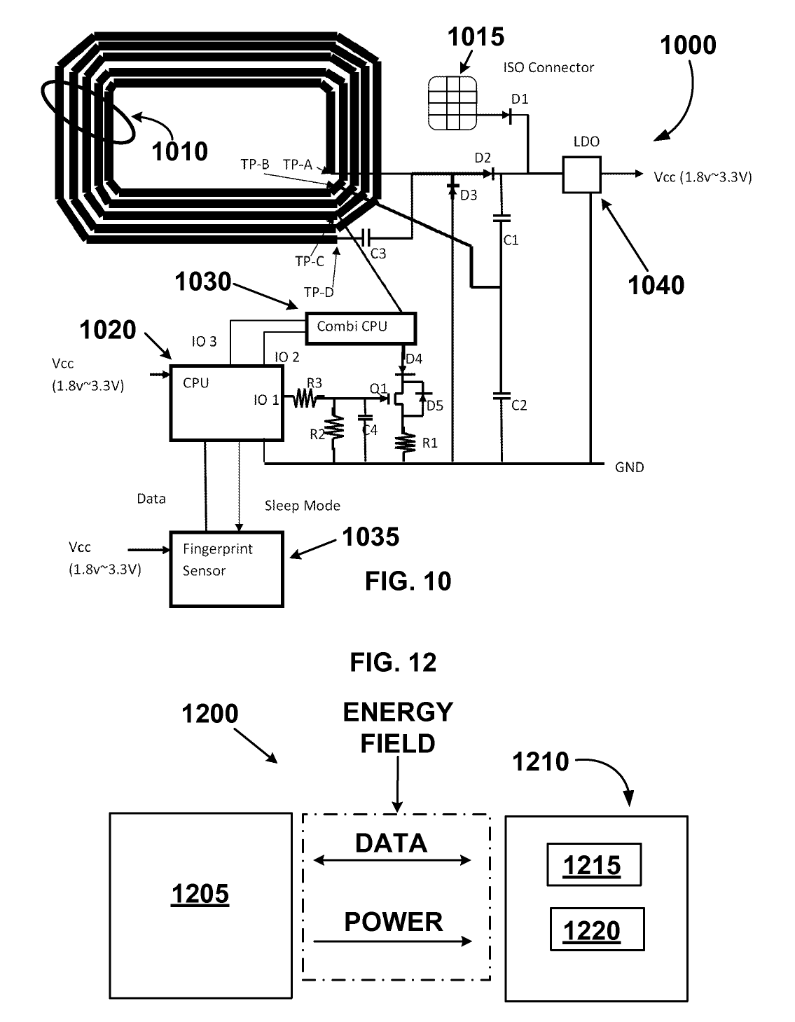

FIG. 10 illustrates a schematic of an alternative RFID tag power circuit and biometric system 1000 in accordance with some embodiments of the present invention. In this system (which is similar to that shown in FIG. 8), multiple processors are used and an RF chip is not used. In addition to CPU 1020, a combination security CPU (Combi CPU) 1030 is used. The combination security CPU 1030 can be used for smart card embodiments and is capable of handling ISO7816 and ISO14443 wireless interface protocols. Further employment of the combination security CPU 1030 enables data transmission from ISO 7816 section to ISO 14443 section. Normally the ISO 14443 section is activated automatically when voltage (Vcc) to Combi CPU is off

In operation, system 1000 functions similar to the biometric device 800 (FIG. 8). Upon a finger print match, however, the CPU 1020 gives power Vcc to the Combi CPU 1030 through IO3. The power can be 3.3 V 5 mA. At the same time, CPU 120 can output voltage from IO3 to to enable Q1. Enabling Q1 allows data to be sent from from IO2 (ISO7816 Protocol) to ISO7816 IO of Combi CPU 1030. The data can be card holder name, matching result as the basic data and for security, send CPU ID, sensor ID and card UID or previous communication record, where all communication can be encrypted by such PKI.

Within Combi CPU, ISO7816 portion write the date in the shared memory of combi CPU, where shared memory can be read by ISO 14443 section and send such read data through antenna, when Vcc to Combi CPU is disconnected. Then upon all necessary data is transmitted from CPU to Combi CPU, then makes IO 3 to be floating. This enables Combi CPU to send data by reading the data in the shared memory written by ISO7816 portion trough antenna. At the same time, by reducing clock to CPU and making finger print sensor to be sleep mode, power consumption of the card is minimized as the ISO 14443 section of security CPU is only active. Regarding the power dissipations, this situation is almost same situation of normal ISO 14443 card and thus the invention can have the similar distance or normal ISO 14443 card, even though it contains intelligence and security.

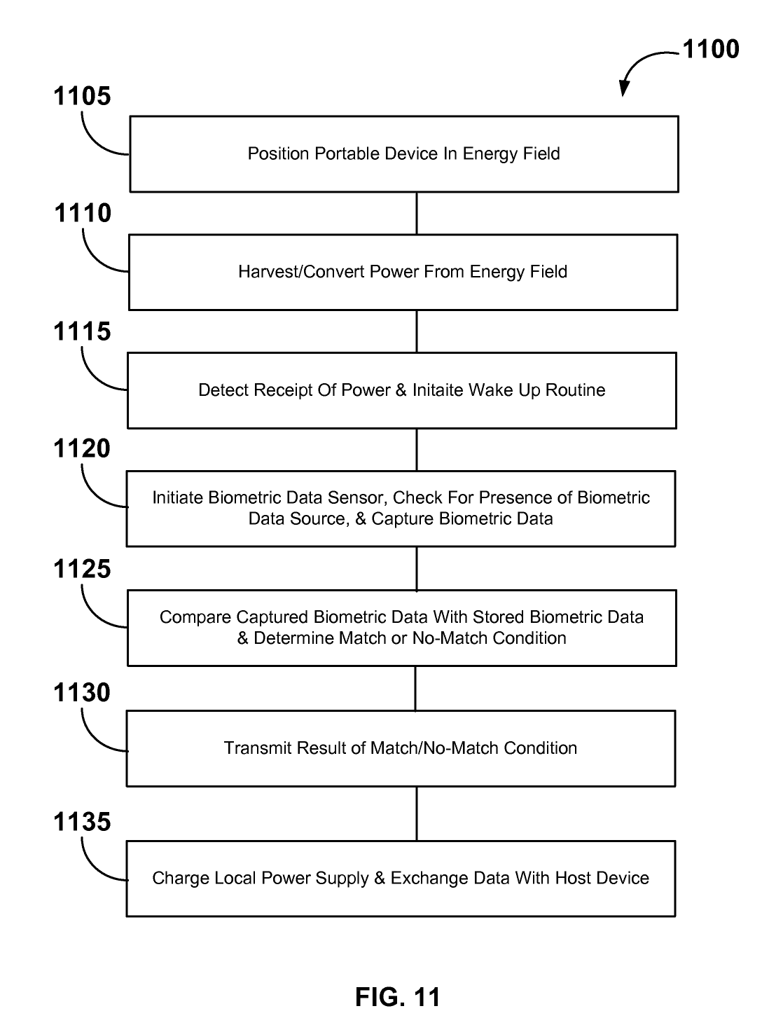

FIG. 11 illustrates a functional logic diagram showing a method 1100 of a mobile (or portable) device being used in an energy field for energy harvesting and data exchange. At 1105, a device is positioned in an energy field. The device can be a portable communication device or a portable access device. The energy field can be provided by any device capable of emitting or giving off an energy field. The energy field can be an RF energy field in some embodiments. In other embodiments, the energy field can higher or lower frequencies. In currently preferred embodiments, the device can be configured to interact with the energy field for multiple purposes.

As shown at 1110, the method 1100 can also include harvesting and converting power from an energy field. This can be accomplished by configuring a portable device to convert wireless energy from the energy field into electrical power. For example, a portable device can include an antenna (as described herein) capable of interacting with an energy field to generate electrical current and voltage. The antenna can be sized and shaped to fit within a small area, like an access card. And in other embodiments, the antenna can be located within a portable communication device. When receiving power from an energy field, the power can be converted from AC to DC; DC power can be used to power both analog and digital devices. The AC can also be used to receive and transmit data.

When brought into an energy field and power transfer occurs, the method 1100 can also include at 1115 detecting receipt of power and an initialization procedure. In some embodiments, non-powered components can be in a sleep (or pause) mode until power detection occurs. Upon detection, for example, a processor can be configured to determine that adequate power is being provided and if so, enter an initialization procedure. The procedure can include ramping up of processor clocking speeds and signaling other components.

In some embodiments, a wake up routine can include a processor being configured to communicate with other components. For example, at 1120, a processor can initiate operations of a biometric data sensor. The data sensor can check for presence of biometric data and capture biometric data. In currently preferred embodiments, biometric data sensors include finger print sensors. Other types of sensors can also be used.

After capturing biometric data with a sensor, the method can include testing of the captured data at 1125. For example, the captured data can be compared with known data for authentication purposes. The comparison can result in a score which can be compared against a threshold. Results of the comparison against the threshold can result in a match or no-match condition.

The method 1100 can also include taking action on a determined match or no-match condition. For example, at 1130, the method 1100 can include communicating the results of the data comparison. The communication can include an RF chip sending a wireless signal about the data comparison. The communication may also include modulating an existing energy field (e.g., field-load modulation). The communication can be in full duplex mode between a host/base device and a portable device.

Communication may occur simultaneously with other method actions. For example, at 1135, while communication exchanges are occurring, power harvesting can be done in a manner to charge a local power supply. Harvesting wireless energy can result in doing away with physical cables/conductors normally required for power harvesting.

FIG. 12 illustrates a functional block diagram of a power harvesting/charging-data transmission system 1200 in accordance with some embodiments of the present invention. Generally, the system 1200 contains a host device 1205 and a portable wireless device 1210. The host device 1205 can include many devices capable of sourcing an RF energy field and capable of receiving/detecting data modulations in an RF data field. The portable wireless device 1210 can include many portable devices capable of interacting with an RF energy field.

In some embodiments, the host device 1205 can be used to charge a power source (e.g., a battery) associated with the portable wireless device 1210. For example, if the portable wireless device is a portable communication device, such as a cell phone or smart phone, having a battery, the portable communication device can include an RF power harnessing circuit as discussed herein. By harvesting the host's device RF energy field, the portable wireless device 1210 can charge its batteries. Since the charging can take place wirelessly, the need for charging devices or power cables does not exist. Charging times can range from fractions of seconds to multiple minutes.

In addition to enabling the charging of local power source, the portable wireless device 1210 can be equipped with circuitry to receive and transmit data from the host device's 1205 RF field. By being able to simultaneously transceive data and charge, the portable wireless data can share data with a network connected to the host device. Data exchanges can be accomplished at varying rates. For example, data exchange rates can include 106, 212, 424 and/or 848 kbit/s.

FIG. 13 illustrates a schematic diagram of a RFID transceiver module 1300 in accordance with some embodiments of the present invention. As shown, the module 1300 includes various analog and digital components. The antenna coil can interact with an energy field to generate AC power. The AC power can be fed to a rectifier (diode D1) for DC conversion. The converted DC can be provided to an op amp A1 (e.g., Texas Instruments Op Amp OPA354 family) as an input source. The op amp can be configured as a comparator and use the converted DC as an input signal. The op amp also has as a reference input a floating reference. The floating reference is provided by a second diode (D2). The second diode D2 allows current to pass so that it functions as a voltage disconnect. The output of the op amp A1 can be data provided in a RF field, such as by an RFID card reader.

In addition to being able to receive data, the module 1300 can also simultaneously transmit data. Data transmission can be accomplished via transistor Q1. Toggling Q1 on and off can result in voltage passing through diode D1 to interact with the antenna coil. This interaction can result in load modulation. The load modulation can be detected/processed by a component to determine the toggling rate of Q1. The toggling rate of Q1 can be used to encode data thereby transmitting data to another component. Using module 1300, data handling can be simultaneous receipt and transmission all the while being powered by an RF energy field.

As discussed herein, the module 1300 can be used for wireless power configurations. For example, the module 1300 can be used in contact and wireless power mode applications (e.g., ISO 7816 and ISO 14443 A, B or Felica). An ISO pad can be used when a card is used as contact type IDO 7816. Voltage (5V or 3.3V) can be supplied through ISO pads. The voltage can be supplied to a voltage regulator, that regulates power to 3.3 V in this case. In case of contact mode, there is no wireless power in some embodiments. In wireless embodiments, there may be no power from ISO pads. The input to voltage regulator can be wired or from contact mode ISO 7816 via pads and Wireless Mode ISO 1443.

The voltage regulator can be used to supply power to a verification CPU and a finger print sensor. In either case, a finger is placed on to fingerprint sensor. Verification CPU supplies power to Dual mode CPU by logically control I/O Such as 10 mA supply able general IO of CPU. The verification CPU can enable or disables Dual mode CPU to send data through antenna or not. Verification CPU can send data from verification CPU to Dual SEC CPU through ISO 7816 IO, using URT IO of the verification CPU. The verification CPU can control the antenna directly so that at initial stage, while voltage is not strong enough. Antenna can not be activated by Dual SEC CPU at any moment, in another word, fail safe control.

FIG. 14 illustrates a schematic diagram of a RFID transceiver module circuit 1400 for use in charging applications in accordance with some embodiments of the present invention. The circuit 1400 is similar to that shown in FIG. 5 so for brevity, this discussion will not repeat identical details. The circuit 1400 can be used in power charging applications. For example, by using a super capacitor in parallel to a stacked pair of capacitors, the super capacitor can be used to charge a power source (e.g., a rechargeable battery). In some embodiments, the super capacitor can have a value ranging from several farads to many farads (e.g., 1 to 1000 farads). Preferably the super capacitor is sized and shaped to be small to fit within small, portable devices.

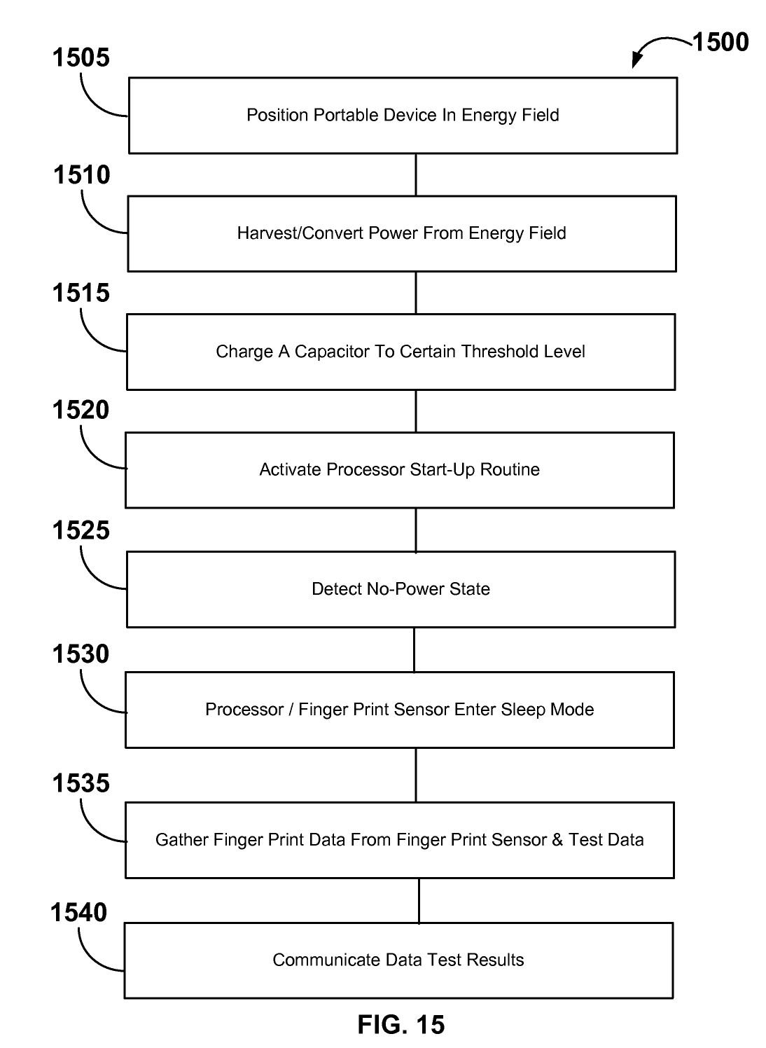

FIG. 15 illustrates a logical flow diagram 1500 of a method that can be used to implement embodiments of the present invention on a mobile device (e.g., an access card). Those skilled in the art will understand that method 1500 can be performed in various orders (including differently than illustrated in FIG. 15), additional actions can be implemented as part of a method embodiment, and that some actions pictured in FIG. 15 or discussed below are not necessary. In addition, it should be understood that while certain actions illustrated in FIG. 15 may be discussed herein as including certain other actions, these certain other actions may be carried out in various orders and/or as parts of the other actions depicted in FIG. 15. Method embodiments of the present invention, such as the one depicted in FIG. 15, may be implemented with the devices and systems discussed herein. Method embodiments may also be coded in a programming language, stored in a memory, and implemented with a processor or microcontroller. Method embodiments can also include the use of component devices and a processor can be used to manage operation of component devices as desired.

The method 1500 can initiate in an initial setting. In an initial setting, there may be no power environment. And as a result, no action is made. When proximate an energy field at 1505, energy can generated via a power circuit at 15 10. The power circuit at 1515 can charge a capacitor. Charging a capacitor can increase voltage output from the capacitor.

If a harnessed voltage is over a CPU activation threshold, a CPU can initiate processing functions at 1520. Or if a CPU does not have such functionality, a dedicated reset circuit can be used. This circuit can be made by RC charging voltage with Schmitt Trigger circuit. If necessary enabling time delay can be added to set up time. If a no-power state is detected at 1525, then the CPU can go into sleep mode for saving energy at 1530. If a no-power state is detected the CPU and biometric sensor can enter a sleep mode.

Sleep modes can also be implemented for power savings. For example, a CPU can enter sleep mode based on a finger print sensor's activity. A CPU can then monitor for a wake up trigger from a finger print sensor, if fingerprint sensor has finger detecting circuit. Such finger detecting circuit can be made by several lines of detection of finger out of whole cell activation. This can save more than 90% of energy of fingerprint sensor. Before detecting fingerprint, this is sleep mode of fingerprint sensor. By this sleep mode of fingerprint sensor and sleep mode of CPU, voltage across the voltage regulator ramps up at maximum speed.

Once a finger is placed in the field of energy where CPU and sensor can operate, the sensor can gather data at 1535. For example, a fingerprint sensor can send wake up commands to CPU (verification CPU), and the CPU can start getting data from fingerprint sensor. As this occurs, only CPU's interface, such as SPI interface and memory, is active to receive data from CPU. For example, a 128×256 bit cell has 8 bit gray scale (262 kb), 10 MHz reading speed takes 0.026 sec, and the power dissipation of sensor is between 0.1 mA to 7 mA depending on sensor type. The current of CPU can be 10 mA at 10 MHz. Total current at this phase is 17 mA.

Once data from fingerprint sensor is transferred to CPU memory, finger print sensor will be in sleep mode again even though finger is on the sensor. Then a taken image data can be processed as image processing to reduce data as convert gray scale data to skinny but continuous line data of fingerprint pattern. This process is done by filtering, such as two dimensional FFT. Then from skinned line data, crossing point, edge of line can be detected by Minutiae processing program. Through this process, minutiae vector can be obtained as personal ID vector data.

This data is compared to the stored reference data in CPU flash memory at 1535. This comparison may not be 100% matching. Rather, the comparison can give a score of matching. Matching can be measured based on the numbers of minutiae to be compared. In the process of matching, angle is to be rotated by A'ffin transfer program. Also, a threshold like FAR (False Acceptance ratio) as 0.1%, as the card can be used only card holder. FRR (False Rejection Ratio as 0.01%) so that mismatch frustration. This threshold adjustment can be FRR<FAR.

After testing the finger print data, test results can be communicated at 1540 to another device. The data communication can include test result and other information. For example, when fingerprint is matched, the CPU can generate data comprising of the event of fingerprint match, Unique ID of CPU, Unique ID of sensor if available, assigned ID of card or along with card holder name, of if required picture of card holder, and or time stamp if useful.

Data transmission can be done in an encrypted fashion. The CPU can encrypt the data to increase security. Encryption protocols can include Triple DES, AREA, Camellio, AES, and RSA. Other encryption schemes can also be employed to meet whatever encryption required by users. PKI can be used as additional encryption and UID, time stamp, or part of Minutiae can be used as private key.

Those information can be generated in Verification CPU, but can be also generated by security CPU, such as dual mode CPU (SEC CPU hereafter), because SEC CPU has coprocessor of encryption. Wireless controller, which is for example, wireless portion of SEC CPU, start shaking hands with card reader. The communications can be wireless and sent through antenna by modulating load of antenna.

The embodiments of the present invention are not limited to the particular formulations, process steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

We claim:

1. A portable wireless device used for event actuation, the portable wireless device comprising:
a wireless power harnessing module that comprises an antenna tuned to a resonant frequency associated with a source of an energy field, the antenna being tuned with a capacitor placed in parallel with the antenna;
the antenna comprising several windings which when proximate the energy field, result in the wireless power harnessing module sourcing power;
a biometric data comparison module coupled to the wireless power harnessing module, the biometric data comparison configured to enter a powered state when receiving adequate power from the wireless power harnessing module, wherein in the powered on state, the biometric data comparison module is operatively configured to receive external biometric data from an external source and compare the external biometric date to stored biometric data; and
a communication module configured to provide information responsive to the comparison of the external biometric date and stored biometric data.

2. The portable wireless device of claim 1, wherein the wireless power harnessing module, the biometric data comparison module, and the communication module reside within an ISO-7816 defined card outline.

3. The portable wireless device of claim 1, wherein the wireless power harnessing module comprises a rectifier circuit coupled to a low impedance winding of the antenna and a common ground, the rectifier circuit configured to convert AC voltage provided by the antenna to DC voltage.

4. The portable wireless device of claim 1, further comprising a capacitor located in parallel with the antenna, wherein the relationship between the capacitor and the antenna defines the resonant frequency.

5. The portable wireless device of claim 1, wherein the device has no local power source.

6. The portable wireless device of claim 1, wherein the antenna is divided up into segments disposed at various tap positions such that antenna has multiple segments configured to carry out multiple functions.

7. The portable wireless device of claim 1, wherein the wireless power harnessing module harness power from the energy field simultaneously to the communication module transmitting and receiving data from the energy field.

8. The portable wireless device of claim 1, wherein the antenna comprises an antenna coil pattern wound in a concentric fashion that comprises inner and outer windings.

9. The portable wireless device of claim 8, wherein the antenna coil pattern is a continuous planar copper trace having tap positions located at various places along the coil pattern so the antenna has multiple segments configured to have different functions.

10. The portable wireless device of claim 1, wherein the wireless power harnessing module comprises a rectifier circuit is a voltage doubling circuits that comprises two Schottky barrier diodes arranged in a full wave rectifying arrangement.

11. A wireless access control device, the device comprising:
a power circuit configured to have a default non-energized state and an energized state, the power circuit configured to receive energy from an energy field to enter the energized state so that the power circuit can source electrical power, wherein the power circuit is finely tuned to a carrier frequency of the energy field; and
a processor coupled to the power circuit, the processor configured to receive electrical power when the power circuit enters the energized state, the processor further configured to receive data from a sensor, and in response to the received data, the processor further configured to generate a signal corresponding to an access level.

12. The wireless access control device of claim 11, wherein the processor receives power only from the power circuit when energized and the processor is not configured to receive power from any other power source.

13. The wireless access control device of claim 11, the power circuit comprising a power detection stage, a power conversion stage, and a receiving antenna, the receiving antenna being integrated with the power detection stage and being shaped and sized to produce electrical power when placed into an energy field.

14. The wireless access control device of claim 11, the power circuit comprising an antenna finely tuned to the carrier frequency of the energy field.

15. The wireless access control device of claim 11, wherein the processor is configured to control data communication between the wireless access control device and the source of the energy field during the energized state.

16. A portable wireless device capable of harnessing wireless energy comprising:
an antenna and a tuning capacitor connected in parallel to form a tank circuit, the tank circuit being finely tuned to a resonant frequency associated with a carrier base frequency of source of an energy field;
the antenna comprising several windings which when proximate the energy field, result in the antenna sourcing electrical current and voltage;
the antenna further comprising a plurality of segments set off by a plurality of taps disposed at various places along the length of the antenna, wherein one of the segments can be configured to receive and transmit data with the energy field simultaneously with receiving energy from the energy field; and
a rectifier circuit connected to a first tap and a second tap of the antenna, the first tap being located on an inner antenna winding and wherein the second tap of the antenna is in electrical communication with a common ground, the rectifier circuit configured to convert the sourced electrical current and voltage to a DC energy source.

17. The portable wireless device of claim 16, further comprising an antenna driving circuit configured to drive the antenna for data communication, the antenna driving circuit being connected to a third tap, the third tap being located on an outer antenna winding.

18. The portable wireless device of claim 16, further comprising a voltage divider capacitor network coupled to the rectifier, the rectifier comprising a pair of Schottky diodes with the cathode of a first diode connected to the anode of a second diode, anode of the first diode connected to ground, and the cathode of the second diode connected to the voltage divider capacitor network.

19. The portable wireless device of claim 18, wherein the voltage divider capacitor network comprises first capacitor connected in parallel to two series connected capacitors, wherein the cathode of the second diode is connected to a positive terminal of the first and second capacitors, and the anode of the first diode is connected to a negative terminal of the first and third capacitors.

20. The portable wireless device of claim 18, wherein capacitors in the voltage divider capacitor range in value from about 1 pF to about 100 pF, the tuning capacitor ranges in value from about 10 pF to 500 pF, the antenna has between 1 to 10 coil windings, and the coil windings have a width ranging between about 1 mm to about 10 mm.

21. The portable wireless device of claim 18, wherein the voltage divider capacitor comprises an energy storage capacitor configured to store energy, the energy storage capacitor having a value ranging from about 0.5 micro-farads to about 1000 farads.

22. A method of harnessing electrical energy from an energy field while simultaneously communicating data with the energy field, the method comprising:
configuring a portable device with a tank circuit tuned to a center frequency of an energy field, wherein an inductor of the tank circuit can interact with the energy field to convert wireless energy into electrical energy so that the inductor can source electrical power; and
configuring a processor located on the portable device to receive electrical power sourced by the inductor and configuring the processor to receive and provide data for communication with a device emitting the energy field, wherein data can be received and transmitted using coils of the inductor while the inductor is sourcing energy.

23. The method of claim 22, further comprising configuring the portable device to receive external biometric data, to test the biometric data against a stored biometric set of data, and to communicate results of the test via the inductor.

24. The method of claim 22, further comprising configuring the processor to communicate data by modulating the field load of the energy field.

25. The method of claim 22, further comprising providing a voltage conversion circuit on the portable device to convert the energy sourced by the inductor from AC to DC and to regulate the DC voltage relative to a predetermined threshold.

26. A computer program product embodied in a computer-readable medium for execution by a processor or engine, the computer program product comprising an algorithm to manage activated carried out by a processor in managing power and testing biometric data, the method comprising:
detecting an appropriate power level being sourced by an antenna that is finely tuned to resonate at a center carrier frequency of an energy field, wherein the power level is provided in electrical form after the antenna converts wireless energy to electrical energy;
communicating with a biometric sensor to determine if the sensor detects presence of biometric data and has captured external biometric data;
testing received biometric data against stored biometric data to determine if the captured external biometric data matches the stored biometric data; and
issuing communication signals for wireless transmission from the antenna to another component, the communication signals comprising data about results of the biometric data test.

27. The method of claim 26, further comprising instructing one of the biometric sensor or a system processor to enter a sleep mode if a low power level state is detected or to preserve power.

28. The method of claim 26, wherein testing received biometric data against stored biometric data includes configuring a system processor to extract digital data from the captured external biometric data to place the external biometric data in the same format as the stored biometric data.

29. The method of claim 26, wherein testing received biometric data against stored biometric data includes generating a score indicative of the data test and wherein the score can determine a positive or negative test result relative to a predetermined threshold.

30. The method of claim 26, wherein testing received biometric data against stored biometric data includes generating a false acceptance ratio and a false rejection ratio and wherein a match condition can be achieved with the false rejection rate is less than the false acceptance ratio.
